(19) United States
(12) Patent Application Publication
(10) Pub. No.: US 2017/0124573 A1
(43) Pub. Date: May 4, 2017

(54) USER PROFILE DATABASE SYSTEM

(71) Applicants: Byron Roy Hall, Nanton (CA); Michael John Holmes, Nanton (CA)

(72) Inventors: Byron Roy Hall, Nanton (CA); Michael John Holmes, Nanton (CA)

(21) Appl. No.: 14/925,611

(22) Filed: Oct. 28, 2015

(51) Int. Cl. G06Q 30/00; G06Q 10/10; G06F 17/30; H04L 29/08

(52) U.S. Cl. CPC G06Q 30/018; H04L 67/1097; G06Q 10/1053; G06F 17/30864

(57) ABSTRACT

A user profile database system comprising a database for storing a plurality of user profile records. Each user profile record comprises a user profile data associated with a human user. The system also includes a processor configured for accepting user profile data from human users and transmitting user profile datum to a third party clearinghouse for verification of each human user's profile data. If said clearinghouse verifies the user profile data from a human user, then a user profile record based on the user profile data is stored in the system's database. The system also provides a graphical user interface for accepting search parameter from a second human user, and wherein the processor is further configured for performing a search of the plurality of user profile records in the database for the search parameters of the second user and displaying search results of said search to the second user.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the field of communications networks, and more specifically to the field of user profile database systems.

### BACKGROUND

Since the advent of the industrial revolution, each individual's place in society have become highly specialized. This has produced various challenges, since a typical person does not have the skills to perform certain everyday tasks, such as dealing with a complex IT issue or producing raw food for consumption. One way to deal with such challenges is to hire a second individual or enterprise to complete said task in order to overcome the first person's challenge. For example, if a first person has a complex IT issue and has no IT experience, then the first person could hire a second person who has appropriate IT experience in order to overcome the first person's challenge. In the past, such first persons relied on a third person's recommendation to determine if the second individual or enterprise was qualified in order to complete the desired task. However, this approach does not always result in a second person who is qualified to do the job required.

In later years, groups were organized to certify that the second individual could perform a required task. For example, a certification body may certify an individual as a Certified Software Engineer adept at handling complex IT issues. As a result, the first person seeking a second individual or enterprise to perform an IT task might check with said authority or certifying group to verify that the second individual or enterprise has the requisite certifications and authorizations to perform a complex IT task. In many cases, however, verifying the requisite certifications and authorizations can be a timely and tedious task. Additionally, in some cases, it may take an inordinately long amount of time for such verification to be completed.

As the Internet evolves, websites have begun to promote potential employees, tradesmen, academic persons, and executives, etc. that objectively have the required qualifications for certain tasks. However, such websites have flaws. For example, a first person might rely on a website's unverified recommendation of a second person. In many cases, the website's recommendations originate from references by unqualified third parties. Further, such recommendations may be based upon a task very different than the task desired by the first party. Because the third-party's recommendation was based upon that third party's own challenges and experiences, which may have been quite different than the first party's challenges, the first party may receive an unqualified candidate. As a result, sometimes existing websites that purportedly provide qualified candidates are actually providing candidates that are inherently unqualified to provide the services required by the first party.

As a result, there is a need for improvements over the prior art, and more specifically, for a more efficient and faster way to certify that an individual meets the criteria required to complete a task.

### SUMMARY

A user profile database system is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, the invention discloses a user profile database system. The user profile database system comprises a database for storing a plurality of user profile records. Each user profile record comprises a user profile data associated with a human user. The system includes a network interface connection for communicatively coupling the user profile database system with a communications network. The system also includes a processor coupled with said network interface connection. The processor is configured for: a) providing a graphical user interface over the communications network, the graphical user interface for accepting user profile data from a human user; b) transmitting to a third party clearinghouse a request for verification of at least a portion of said user profile data from the human user; c) if said clearinghouse verifies said at least a portion of said user profile data from the human user, then generating a user profile record based on said user profile data accepted from the human user; d) providing a second graphical user interface over the communications network, the graphical user interface for accepting login data from a second human user; e) authenticating said second human user based on the login data; f) providing a graphical user interface over the communications network to said second human user, the graphical user interface for accepting search parameters from said second human user; g) performing a search of the plurality of user profile records in the database for the search parameters; and, h) providing a graphical user interface over the communications network to said second human user, the graphical user interface for displaying search results of said search.

### BRIEF DESCRIPTION OF THE DRAWINGS

The accompanying drawings, which are incorporated in and constitute a part of this disclosure, illustrate various example embodiments. In the drawings:

FIG. 1 is a diagram of an operating environment that supports a user profile database system over a communications network, according to an example embodiment;

FIG. 2 is a chart showing the data flow of a process for providing to a user a plurality of verified profile records, over the communications network, according to an example embodiment;

FIG. 3 is a flow chart showing the data flow of a process of providing first user profile data for verification by a third party clearinghouse, over the communications network, according to an example embodiment;

FIG. 4 is a flow chart showing the data flow of a process for a second user to perform a search, over a communications network, according to an example embodiment; and,

FIG. 5 is a block diagram of a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

The present invention provides a user profile database system that improves over the prior art by providing a plurality of candidates that each have been verified by a third-party clearinghouse. The present invention improves over the prior art by quickly and efficiently providing a means for a first user to find qualified candidates that have had their credentials verified by third-party clearinghouse. The present invention also improves over the prior art by allowing a first user to search quickly and efficiently for verified and qualified candidates located in the geographical areas that they require. The present invention allows the first user to ensure that a candidate or second user has the educational background, area of expertise, work experience and qualifications etc. that match the requirements of the first user.

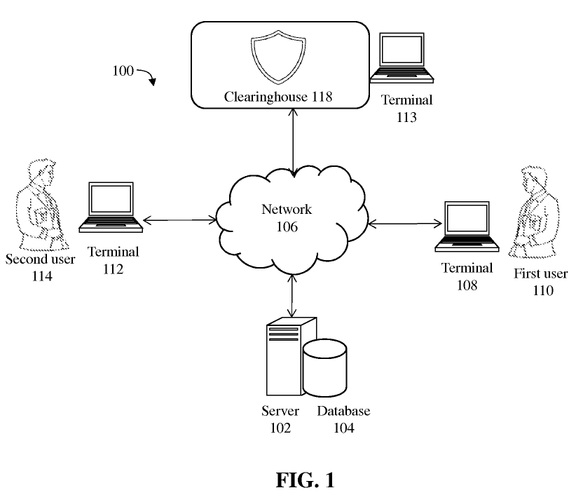

Referring now to the figures, FIG. 1 is a diagram of an operating environment that supports a user profile database system over a communications network, according to an example embodiment. FIG. 1 is a diagram of an operating environment or system 100 that supports a user profile database coupled to a communications network 106, according to an example embodiment. The environment 100 may comprises terminals 108, 112, 113 all of which may communicate with server 102 via a communications network 106. Terminals 108, 112, 113 and servers 102 may comprise any computing device, such as integrated circuits, printed circuit boards, processors, ASICs, PCBs, cellular telephones, smart phones, tablet computers, desktop computers, laptops, and game consoles, for example.

Terminals 108, 112, 113 and servers 102 may be connected either wirelessly or in a wired or fiber optic form to the communications network 106. Communications network 106 may one or more packet switched networks, such as the Internet, or any local area networks, wide area networks, enterprise private networks, cellular networks, phone networks, mobile communications networks, or any combination of the above. In one embodiment, Terminals 108, 112, 113 and servers 102 is a programmable logic controller or PLC.

Server 102 includes a software engine that delivers applications, data, program code and other information to networked terminals 108, 112 and 113. The software engine of server 102 may perform other processes such as transferring multimedia data in a stream of packets that are interpreted and rendered by a software application as the packets arrive.

FIG. 1 further shows that server 102 includes a database or repository 104, which may be a relational database comprising a Structured Query Language (SQL) database stored in a SQL server or a database that adheres to the noSQL paradigm. The database 104 may serve data, as well as related information, used by server 102 and terminals 108, 112, and 113 during the course of operation of the invention.

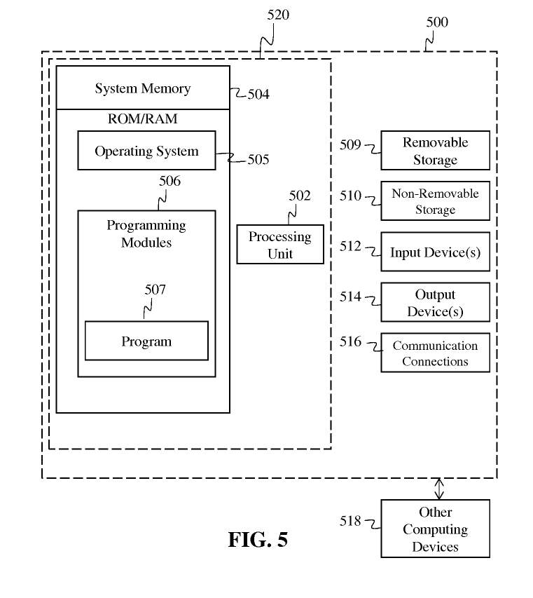

Terminals 108, 112, 113 and server 102 may each include program logic comprising computer source code, scripting language code or interpreted language code that perform various functions of the present invention. In one embodiment, the aforementioned program logic may comprise program module 507 in FIG. 5. It should be noted that although FIG. 1 shows only one first user terminal 108, only one second user terminal 112, only one clearinghouse terminal 113 and one server 102, the system of the present invention supports any number of terminals, servers, mobile devices connected via network 106. Also note that although server 102 is shown as a single and independent entity, in one embodiment, server 102 and its functionality can be realized in a centralized fashion in one computer system or in a distributed fashion wherein different elements are spread across several interconnected computer systems. Also note that although clearinghouse 118 is shown as a single and independent entity, in one embodiment, clearinghouse and its functionality can be realized in a centralized fashion in one computer system or in a distributed fashion wherein different elements are spread across several interconnected computer systems.

Various types of data may be stored in the database 104 of server 102. For example, the database 104 may store one or more user profile records associated with each of a plurality of users. The server 102 may comprise a processor that is coupled with a network interface connection and is configured for providing, over the communications network, a graphical user interface. The graphical user interface may be configured for accepting user profile data input by first user 110 into the graphical user interface display on or at terminal 108.

Additionally, the system may also include a processor that is coupled with the network interface connection and is configured for providing a second graphical user interface to a second user 114. The graphical user interface can be configured to accept search parameters from a second user and for authenticating the second human user based upon login data provided by the second user at time of registration. The graphical user interface may comprise a webpage, or other display or program adapted to be received by terminal 114.

The system may also include a processor that is coupled with the network interface connection and that is capable of transmitting to a third-party clearinghouse 118 a request for verification of at least a portion of said user profile data from first human user 110. The request may be received by the clearinghouse at terminal 113. The third-party clearinghouse may be connected to separate servers and processors that allow for the clearinghouse to verify the data provided by the first user 110. Additionally, the clearinghouse may conduct research via the telephone, Internet, face-to-face interaction, etc. to verify the profile data received by a human user.

Each of the user profile records can include the profile data of a human user. The profile data can comprise a user's name, contact information, educational background, area of expertise, a plurality of work experience data, a plurality of certification data, and a plurality of salary data. Other data may also be used and is within the spirit and scope of the invention. A user's contact information can include email address, cell phone number, home number, fax number, website, home address, office address etc.

A user's educational background can include data from high school, undergraduate education, trade school education, postgraduate education, doctoral education etc. Similarly, a user's work experience can include apprenticeships, where the user worked, the name of the business or entity that the user work for, etc. The certification data may include certificates from professional associations, trade associations, licensing associations etc. The salary data may include what the user has worked for in the past, what the user is willing to work for in the future, the average rate for the services or products that the user is willing to provide, the user's hourly rate, rate per unit of measurement, rate for project, fixed rates etc.

The user profile data be input using a graphical interface displayed on terminals. In one embodiment, the graphical user interface can be a webpage that appears on the display screen of terminal 108 of the first user 110. In other embodiments the graphical user interface can be specifically designed for such terminal. The graphical user interface can be provided by the processor over the communications network and such graphical user interface is for accepting the profile data from the human user.

The database 104 may also be configured for receiving and storing login data from the second user 114. The login data may be entered into the graphical user interface of device 112 at a time the second user 114 registers with the system. The login data may include a username and authentication password, as well as contact information, such as telephone number, fax number, website address, email address, physical home address, office address etc.

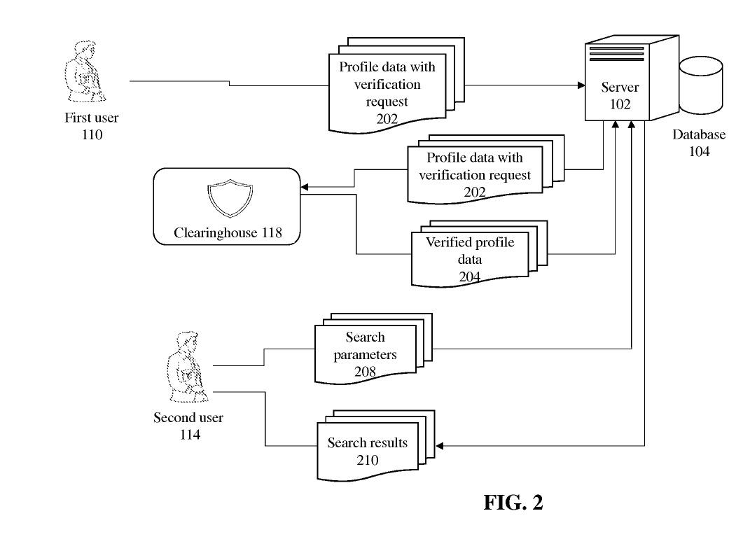

FIG. 2 is a flow chart showing the data flow of a process for providing to a user a plurality of verified profile records, over the communications network, according to an example embodiment. The system can be used as a method for providing a qualified candidate for employment, independent contracting, part time employment, full time employment or any other activity that requires verification of a person or candidate's credentials. The system is configured for the first user 110 to provide profile data and a request for verification of such data 202. The request may be sent using HTTP or any other means known to those skilled in the art. As mentioned above, the profile data can include a user's name, contact information, educational background, area of expertise, a plurality of work experience data, a plurality of certification data, and a plurality of salary data. The graphical user interface 108 may be adapted for accepting copies of documents, such as Social Security cards, driver's license, transcripts etc., which may act as supporting data for verification purposes.

The processor of the system is also configured for receiving and transmitting to the third-party clearinghouse 118 the first user's profile data for verification of the veracity of such data. The clearinghouse will verify at least a portion of the user profile data received from the first user. The clearinghouse may verify such data using additional processors and databases, face-to-face interaction, telephone etc., or any other means known to those skilled in the art in order to determine the veracity of the data provided by the first user by the first user.

If the clearinghouse 118 verifies at least a portion of the first user data of the first user profile record, then the processor can generate a user profile record based upon the first user's profile data accepted and verified by the clearinghouse. The user profile record is stored within the user profile database.

The second user 114 can register using the graphical user interface on terminal 112. During the registration of the second user, the processor accepts the login data on the graphical user interface from the second user. The login data may include a username and authentication password, geographical location, contact information, such as telephone number, fax number, website address, email address, physical home address, office address etc. the processor is also configured for, after registration of the second user, authenticating the second user based upon the login data entered into the graphical user interface by the second user.

The processor is also configured for performing a search of the plurality of user profile records, which have been verified by the third-party clearinghouse and have been stored in the database, based upon search parameters 208 entered into by the second user on the graphical user interface of the second terminal 112. In one embodiment, the search parameters can include a geographic range, an educational prerequisite threshold, work experience prerequisite threshold, a certification prerequisite threshold, and a salary range. These parameters are not meant to be a limitation and other parameters can also be used.

For example, a user may require a lawyer having graduated from a certain institution of higher learning, having a certain number of years of work experience, willing to work for a certain maximum amount and that is located within a certain geographical region. Additionally, the system may be used for verifying candidates for employment, candidates for construction work, candidates for professional services etc.

The processor is configured for conducting the search using the search parameters and providing search results 210 to the second user. The search results may be provided to a graphical user interface over the communications network, wherein the graphical user interface is adapted for displaying the results of the search.

The processor is also further configured for assigning a grade to each user profile listed in the plurality of search results. The grade assigned identifies a percentage of match for each user profile record to the second user's search parameters. In other embodiments, the system assigns a ranking to each user profile record of the search results based upon comparing a verified user profile record to the second user search parameters. The greater amount of verified user profile data that matches the parameters of the second data the higher the assigned ranking. In other embodiments, the user profile appearing first on a list of plurality of records will have the highest grade. In other words, the first user profile on a list will be the profile that most closely matches the parameters entered into by the second user 114.

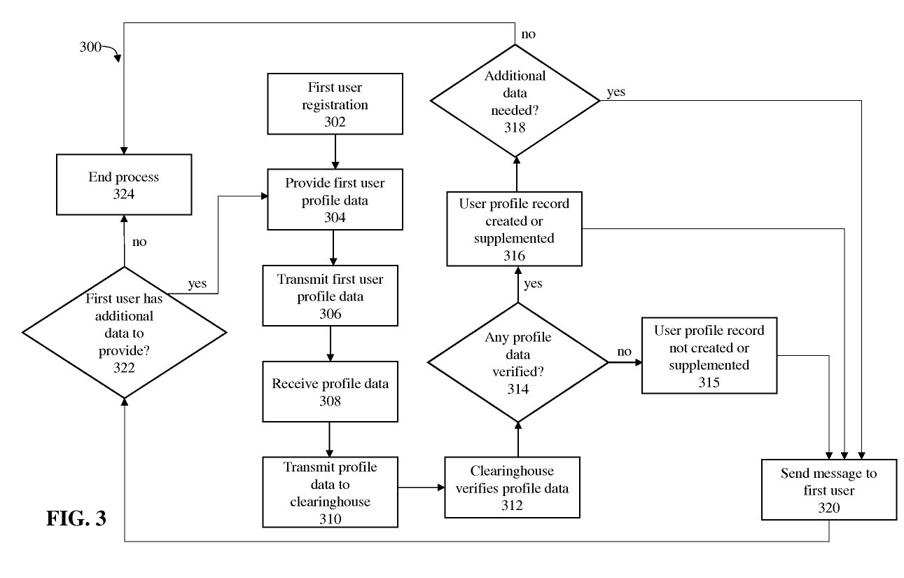

FIG. 3 is a flow chart showing the data flow of a process 300 of providing first user profile data for verification by a third party clearinghouse, over the communications network, according to an example embodiment. In step 302, the first user registers with the system. The registration process may include providing authentication passwords, username, address information, and registration details that are well known to those skilled in the art. After registering, the flow moves to step 304. In step 304, the first user provides for authentication user profile data accepted by a graphical user interface provided by the processor of the system. The user profile data may include information input into the graphical user interface, which can be input via scanner, microphone, keyboard, and may include supporting documentation such as transcripts, paychecks, certificates, etc. Next, the process moves to step 306 and the user profile is transmitted, over a communications network to a third-party clearinghouse for a request for verification. Next, the profile data is received in step 308 at terminal 113 of clearinghouse 118. The terminal 113 may be a graphical user interface that allows the clearinghouse to display and process the user profile data.

Next, in step 314, the clearinghouse may use any method necessary to verify the profile data of the user. If none of the user profile data is verified, then the process flow moves to step 315 and a user profile is not created. If any of the profile data has been verified, then the process flow moves to step 316.

In step 316, a user profile record can be created. The user profile record includes the user profile data that has been verified from the clearinghouse. Optionally, the system may also include step 318 for determining if additional data is necessary or needed in order to verify or certify any portion of the first user profile. If additional information is needed, then the process may move to step 320. If no additional information is needed, then the process may move to step 324 completing the process.

In one embodiment a message can be sent to the first user, as shown in step 320. In step 320, the clearinghouse and/or processor may include reasons why certain data received from the user was not verified and requesting additional data such as additional information or supporting documentation.

In step 322, the first user can determine if additional data can be provided through the graphical user interface of the terminal 108 that will facilitate verification of the first user's profile data. If additional information can be submitted and accepted by the graphical user interface, then the process moves back to step 304. On the other hand, if the user has no additional information then the process flow moves to step 324 and the process ends.

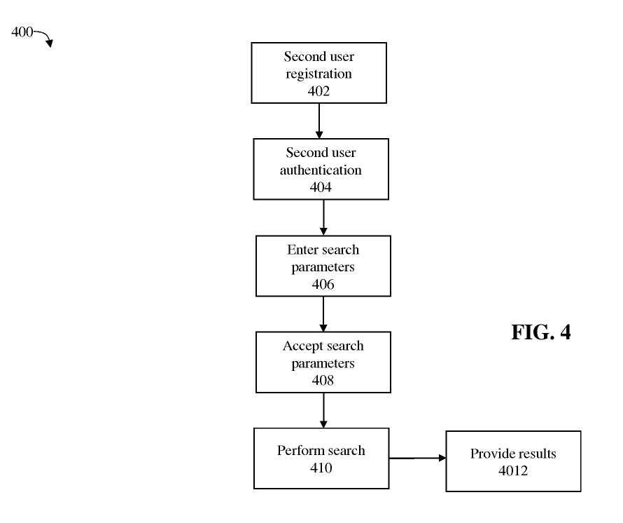

FIG. 4 is a flow chart showing the data flow of a process 400 for a second user to perform a search, over a communications network, according to an example embodiment. In step 402, a second user registers with the system. The registration may include login data that is accepted by the graphical user interface provided by the processor of the system over the communications network coupled with the network interface connection. Next, in step 404, the second user can login to the system by providing the login data. The processor of the system will authenticate the second user based upon the login data provided into the graphical user interface of the terminal 112.

Next, in step 406, the second user can enter insert parameters into the graphical user interface in order to search for qualified candidates verified by the clearinghouse. Next, in step 408, the processor accepts such search parameters and performs a search of the plurality of user profile records that have been verified by the clearinghouse and stored in the database. Next, the processor can display to the second user the results that match the parameters entered by the second user using a graphical user interface.

Optionally, the processor is configured for assigning a grade to each user profile record of the search results. As mentioned above, each grade can identify a percentage of match for each user profile record to the second user's search parameters. The purpose of assigning a grade is to indicate to the second user how closely and which user profiles most closely match the requirements of the second user.

FIG. 5 is a block diagram of a computing device, according to an example embodiment. FIG. 5 is a block diagram of a system including an example computing device 600 and other computing devices. Consistent with the embodiments described herein, the aforementioned actions performed by terminal 108, 112, 113 and server 104 may be implemented in a computing device, such as the computing device 500 of FIG. 5. Any suitable combination of hardware, software, or firmware may be used to implement the computing device 500. The aforementioned system, device, and processors are examples and other systems, devices, and processors may comprise the aforementioned computing device. Furthermore, computing device 500 may comprise an operating environment for processes 200, 300, and 400 as described above. Processes 200, 300 and 400 may operate in other environments and are not limited to computing device 500.

With reference to FIG. 5, a system consistent with an embodiment of the invention may include a plurality of computing devices, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination or memory. System memory 504 may include operating system 505, and one or more programming modules 506. Operating system 505, for example, may be suitable for controlling computing device 500's operation. In one embodiment, programming modules 506 may include, for example, a program module 507 for executing the actions of 108, 112, 113 and server 104, for example. Furthermore, embodiments of the invention may be practiced in conjunction with a graphics library, other operating systems, or any other application program and is not limited to any particular application or system. This basic configuration is illustrated in FIG. 5 by those components within a dashed line 520.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a camera, a touch input device, etc. Output device(s) 514 such as a display, speakers, a printer, etc. may also be included. The aforementioned devices are only examples, and other devices may be added or substituted.

Computing device 500 may also contain a communication connection 516 that may allow device 500 to communicate with other computing devices 518, such as over a network in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 504, including operating system 505. While executing on processing unit 502, programming modules 506 (e.g. program module 507) may perform processes including, for example, one or more of the stages of the process 500 as described above. The aforementioned processes are examples, and processing unit 502 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A user profile database system, comprising:
a database for storing a plurality of user profile records, each user profile record comprising user profile data associated with a human user;
a network interface connection for communicatively coupling the user profile database system with a communications network;
a processor coupled with said network interface connection, the processor configured for:
providing a graphical user interface over the communications network, the graphical user interface for accepting user profile data from a human user;
transmitting to a third party clearinghouse a request for verification of at least a portion of said user profile data from the human user;
if said clearinghouse verifies said at least a portion of said user profile data from the human user, then generating a user profile record based on said user profile data accepted from the human user;
providing a second graphical user interface over the communications network, the graphical user interface for accepting login data from a second human user;
authenticating said second human user based on the login data;
providing a graphical user interface over the communications network to said second human user, the graphical user interface for accepting search parameters from said second human user;
performing a search of the plurality of user profile records in the database for the search parameters; and,
providing a graphical user interface over the communications network to said second human user, the graphical user interface for displaying search results of said search.

2. The database system of claim 1, wherein the profile data comprises a user's name, contact information, educational background, area of expertise, a plurality of work experience data, a plurality of certification data, and a plurality of salary data.

3. The database system of claim 1, wherein the second human login data comprises a second user name, second user contact information and a second user geographic location.

4. The database system of claim 1, wherein the search parameters include a geographic range, an educational prerequisite value, a work experience prerequisite value, a certification prerequisite value and a salary range.

5. The database system of claim 1, wherein the request for verification is sent via HTTP.

6. The database system of claim 1, wherein the processor is further configured for transmitting a request for additional verification information from a user.

7. The database system of claim 1, wherein the processor is further configured for assigning a grade to each user profile record of the search results, wherein the grade identifies a percentage of match for each user profile record to the second user's search parameters.

8. A method for providing a candidate for employment comprising:
a database for storing a plurality of user profile records, each user profile record comprising user profile data associated with a human user;
a processor coupled with said network interface connection, the processor configured for:
receiving, over a communications network, a plurality of user profile data associated with a human user;
transmitting, over a communications network, to a third party clearinghouse a request for verification of at least a portion of said user profile data from the human user;
receiving, over a communications network, from the third party clearinghouse a message with at least one verified profile datum of the human user;
storing, in an associated database, a plurality of user profile records, each user profile record comprising user verified profile data associated with a human user;
accepting, over a communications network, login data from a second human user;
authenticating, over a communication network, said second human user based on the login data;
accepting, over a communications network, search parameters from said second human user;
performing a search of the plurality of user profile records in the database for the search parameters;
providing, over a communications network, to a second user search results of said search;
assigning a grade to each user profile record of the search results, wherein the grade identifies a percentage of match for each user profile record to the second user's search parameters; and,
wherein a network interface connection communicatively couples the database with a communications network

9. The method of claim 8, wherein the profile data comprises a user's name, contact information, educational background, area of expertise, a plurality of work experience data, a plurality of certification data, and a plurality of salary data.

10. The method of claim 9, wherein the second human login data comprises a second user name, second user contact information and a second user geographic location.

11. The method of claim 10, wherein the search parameters comprise a geographic predetermined range, an educational prerequisite value, a work experience prerequisite value, a certification prerequisite value and a salary range.

12. The method of claim 11, wherein the request for verification is sent via HTTP.

13. The method of claim 12, wherein the method further comprises transmitting a request for additional verification information from a user.

14. A user profile database system, comprising:
a database for storing a plurality of user profile records, each user profile record comprising user profile data associated with a human user, wherein the profile data comprises a user's name, contact information, educational background, area of expertise, a plurality of work experience data, a plurality of certification data, and a plurality of salary data;
a network interface connection for communicatively coupling the user profile database system with a communications network;
a processor coupled with said network interface connection, the processor configured for:
providing a graphical user interface over the communications network, the graphical user interface for accepting user profile data from a human user;
transmitting to a third party clearinghouse a request for verification of at least a portion of said user profile data from the human user;
if said clearinghouse verifies said at least a portion of said user profile data from the human user, then generating a user profile record based on said user profile data accepted from the human user;
providing a graphical user interface over the communications network, the graphical user interface for accepting login data from a second human user, wherein the login data comprises a second user name, second user contact information and a second user geographic location;
authenticating said second human user based on the login data;
providing a graphical user interface over the communications network to said second human user, the graphical user interface for accepting search parameters from said second human user, wherein the search parameters comprise a geographic predetermined range, an educational prerequisite value, a work experience prerequisite value, a certification prerequisite value and a salary range;
performing a search of the plurality of user profile records in the database for the search parameters;
providing a graphical user interface over the communications network to said second human user, the graphical user interface for displaying search results of said search;
assigning a ranking to each user profile record of the search results based upon comparing a verified user profile record to the second user search parameters, wherein the greater amount of verified user profile data that matches the parameters of the second data the higher the assigned ranking.

15. The database system of claim 14, wherein the request for verification is sent via HTTP.

16. The database system of claim 15, wherein the processor is further configured for transmitting a request for additional verification information from a user.
